(19) United States
(12) Patent Application Publication
(10) Pub. No.: US 2025/0247521 A1
(43) Pub. Date: Jul. 31, 2025

(54) OUT-OF-BOUNDARY CHECK IN VIDEO CODING

(71) Applicant: MEDIATEK INC., Hsinchu City (TW)

(72) Inventors: Yu-Ling HSIAO, Hsinchu City (TW); Chih-Wei HSU, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/997,274

(22) PCT Filed: Jun. 27, 2023
(86) PCT No.: PCT/CN2023/102691

§ 371 Date: Jan. 21, 2025

Related U.S. Application Data
(60) Provisional application No. 63/369,087, filed on Jul. 22, 2022.

(51) Int. Cl. H04N 19/105; H04N 19/159; H04N 19/176; H04N 19/577

(52) U.S. Cl. CPC H04N 19/105; H04N 19/159; H04N 19/176; H04N 19/577

(57) ABSTRACT

A method of coding pixel blocks using out-of-bound (OOB) checks is provided. A video coder receives data to be encoded or decoded as a current block of a current picture of a video. The video coder identifies a first reference block in a first reference picture based on a first block vector of the current block. The video coder performs OOB check for the first reference block relative to a boundary of a sub-unit of the first reference picture. The video coder generates a predictor for the current block based on the first reference block and based on the OOB check. When a sample of the first reference block is OOB, the sample is not used in a bi-directional motion compensation for the current block. The video coder encodes or decodes the current block by using the generated predictor.

### CROSS REFERENCE TO RELATED PATENT APPLICATION(S)

The present disclosure is part of a non-provisional application that claims the priority benefit of U.S. Provisional Patent Application No. 63/369,087, filed on 22 Jul. 2022. Content of above-listed application is herein incorporated by reference.

### TECHNICAL FIELD

The present disclosure relates generally to video coding. In particular, the present disclosure relates to methods of coding pixel blocks with out-of-bound (OOB) checks.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method of coding pixel blocks using out-of-bound (OOB) checks. A video coder receives data to be encoded or decoded as a current block of a current picture of a video. The video coder identifies a first reference block in a first reference picture based on a first block vector of the current block. The video coder performs OOB check for the first reference block relative to a boundary of a sub-unit of the first reference picture. The sub-unit may be a slice, a tile, or a pipeline data unit of the first reference picture.

The video coder generates a predictor for the current block based on the first reference block and based on the OOB check. For example, when a sample of the first reference block is OOB, the sample is not used in a bi-directional motion compensation for the current block. The encoder may identify a second reference block in a second reference pictures based on a second block vector of the current block, and may perform OOB check for the second reference block. The predictor may be generated for bi-directional motion compensation based on the first and second reference blocks and based on the OOB checks of the first and second reference blocks.

In some embodiments, the current block may be one of a plurality of sub-blocks of a larger block, and the OOB check of the first reference block is performed on only one representative pixel position in the first reference block. The representative pixel position may be a fractional position. The size of a sub-block may be determined based on a coding tool that is used for encoding or decoding the current block.

For each sub-block, the encoder may identify a reference block in a reference picture, perform OOB check for the identified reference block relative to a boundary of a sub-unit of the reference picture at only the representative pixel position and no other pixel position in the reference block, and determines whether to perform bi-directional motion compensation for all samples of the sub-block based on the OOB check at the representative pixel position. The encoder may derive a corresponding motion vector from multiple motion vectors of the sub-block, and may use the corresponding motion vector to identify a reference block for the sub-block. In some embodiments, the corresponding motion vector of the sub-block is derived from calculating the minimum or the maximum of horizontal and vertical components of the multiple motion vectors of the sub-block.

In some embodiments, when a sample of the first reference block is OOB, the sample is not used in a bi-directional motion compensation for the current block. In some embodiments in which the current block is one of several sub-blocks of the larger block, when a sample at the representative pixel position is OOB, the bi-directional motion compensation is not applied for the sub-block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates bi-directional prediction with out-of-bound (OOB) reference blocks.

FIGS. 2A-B illustrate OOB check being performed based on different types of boundaries.

FIG. 3 conceptually illustrates performing OOB check at sub-block level.

FIG. 4 illustrates an example video encoder that may use out-of-bound checks when performing prediction modes.

FIG. 5 illustrates portions of the video encoder that implement out-of-bound checks for predictive coding.

FIG. 6 conceptually illustrates a process for using out-of-bound checks when performing predictive coding of a block of pixels.

FIG. 7 illustrates an example video decoder that may use out-of-bound checks when performing prediction modes.

FIG. 8 illustrates portions of the video decoder that implement out-of-bound checks for predictive coding.

FIG. 9 conceptually illustrates a process for using out-of-bound checks when performing predictive coding of a block of pixels.

FIG. 10 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Out-of-Boundary (OOB) Check

### A. OOB Check for Bi-Directional Motion Compensation

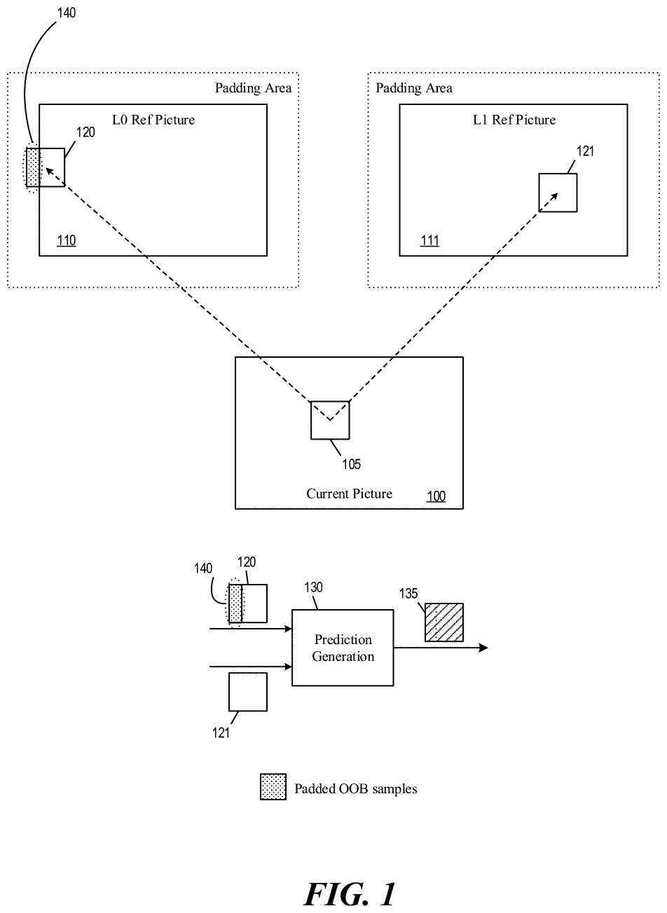

It is possible for an inter-predicted CU to have a reference block located outside the reference picture partially or totally. FIG. 1 illustrates bi-directional prediction with out-of-bound (OOB) reference blocks. In the figure, bi-directional motion compensation is performed to generate an inter prediction block (predictor) of a current block 105 in a current picture 100. A list 0 reference block 120 is partially out-of-boundary (OOB) of a reference picture 110. A list 1 reference block 121 is fully inside a reference picture 111. The OOB portion 140 of the reference block 120 is filled with repetitive padding samples when the video coder performing a prediction generation process 130. The prediction generation process 130 uses the reference blocks 120 and 121 to generate a prediction block 135 for the current block 105. Since the OOB portion 140 of the reference block 120 is padded with repetitive samples derived from the boundary samples within the reference picture 110, the part of a motion compensated block 135 that correspond to the OOB portion 140 may provide less prediction efficiency.

In some embodiments, a uni-directional motion compensated sample is regarded as OOB when one of its reference samples is located outside the reference picture beyond half sample. For each prediction sample in a bi-directional motion compensated block, when one of its uni-directional prediction samples is OOB and the other one is non-OOB, the corresponding bi-directional sample is set equal to the non-OOB sample instead of using an average of the OOB and non-OOB samples.

In some embodiments, when combining more than one prediction blocks, the OOB prediction samples are discarded, and the non-OOB prediction samples are used to generate the final predictor. Specifically, let Pos_x_{i,j} and Pos_y_{i,j} denote the x and y positions of one prediction sample (i, j) in one current block, and MV^{LX}_x_{i,j} and MV^{LX}_y_{i,j} (LX=L0 or L1) denote the MV of the current block; Pos_{LeftBdry}, Pos_{RightBdry}, Pos_{TopBdry}, Pos_{BottomBdry} are the positions of four boundaries of the picture. One prediction sample is regarded as OOB when at least one of the following conditions is satisfied:

$$( {Pos\_x}_{i , j} + {MV}^{LX} {\_x}_{i , j} ) > ( {Pos}_{RightBdry} + half\_pixel ) ,$$

$$( {Pos\_x}_{i , j} + {MV}^{LX} {\_x}_{i , j} ) < ( {Pos}_{LeftBdry} + half\_pixel ) ,$$

$$( {Pos\_y}_{i , j} + {MV}^{LX} {\_y}_{i , j} ) > ( {Pos}_{BottomBdry} + half\_pixel ) ,$$

$$( {Pos\_y}_{i , j} + {MV}^{LX} {\_y}_{i , j} ) > ( {Pos}_{TopBdry} + half\_pixel ) ,$$

where half pixel is equal to 8 that represents the half-pel sample distance in the 1/16-pel sample precision. After examining the OOB condition for each sample, the final prediction samples of one bi-directional block is generated as follows:

$$If {P}_{i , j}^{L 0} is OOB and {P}_{i , j}^{L 1} is non - OOB , then {P}_{i , j}^{final} = {P}_{i , j}^{L 1}$$

$$else if {P}_{i , j}^{L 0} s non - OOB and {P}_{i , j}^{L 1} is OOB , then {P}_{i , j}^{final} = {P}_{i , j}^{L 0}$$

$$else {P}_{i , j}^{final} = ( {P}_{i , j}^{L 0} + {P}_{i , j}^{L 1} + 1 ) ≫ 1$$

In some embodiments, OOB checks are performed for intra-coded blocks or IBC blocks. For example, a current block may be coded by block vectors that reference prediction samples in the current pictures, and the OOB checks are performed on the referenced samples. The samples determined by the OOB check to be OOB may be replaced by padding samples, or, if the current block is coded by multiple predictors (e.g., bi-prediction or multi-hypothesis), the OOB prediction samples will not be used, and the collocated non-OOB samples of other predictors are used to generate the final predictor.

### B. OOB Check Based on Sub-Picture Boundaries

In some embodiments, the boundary of OOB check may be any one of picture boundary, sub-picture boundary, tile boundary, slice boundary, a virtual pipeline data unit (e.g., VPDU) boundary, or virtual boundary. (Data pipeline units are defined as non-overlapping square/rectangle units in a picture. In hardware decoders, successive data pipeline units are processed by multiple pipeline stages at the same time. Different stages process different pipeline unit simultaneously.) In the example of FIG. 1, the OOB check is performed based on a picture boundary.

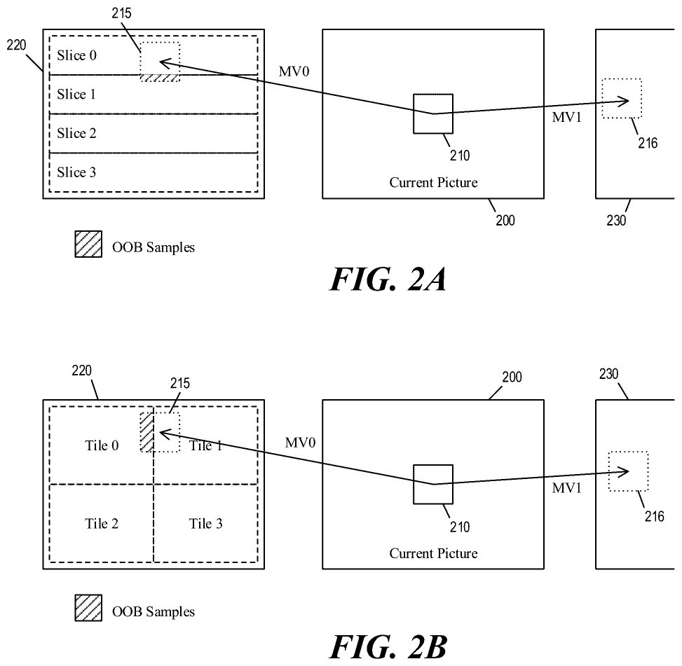

FIGS. 2A-B illustrate OOB check being performed based on different types of boundaries. The OOB check is performed on L0 and L1 reference blocks that are used for bi-directional motion compensation. As illustrated, a current block 210 in a current picture 200 is coded using bi-directional motion compensation. The current block 210 has a L0 motion vector MV0 and a L1 motion vector MV1. MV0 points to a L0 reference block 215 in a L0 reference picture 220. MV1 points to a L1 reference block 216 in a L1 reference picture 230.

FIG. 2A illustrates OOB check being performed on slice boundaries. The L0 reference picture 220 is divided into multiple slices (slice 0 through slice 3). The reference block 215 is in slice 0, but part of reference block 215 crosses slice boundary into slice 1 and therefore fails OOB check. The video coder may exclude the OOB samples of the reference block 215 from the bi-directional motion compensation.

FIG. 2B illustrates OOB check being performed on tile boundaries. The L0 reference picture 220 is divided into multiple tiles (Tile 0 through Tile 3). The reference block 215 is in Tile 1, but part of reference block 215 crosses tile boundary into Tile 0 and therefore fails OOB check. The video coder may exclude the OOB samples of the reference block 215 from the bi-directional motion compensation.

### C. Sub-Block Based OOB Check

In some embodiments, the OOB check is applied at sub-block level rather than at sample level. In some of these embodiments, the video coder uses one representative position in a sub-block and a corresponding MV (of the sub-block) to determine the OOB results of all positions in the sub-block. For example, for a 4×4 sub-block, the video coder may use the position (2, 2) (assume the position of left-top one is (0, 0)) as the representative pixel position to determine the OOB results of all positions in the sub-block.

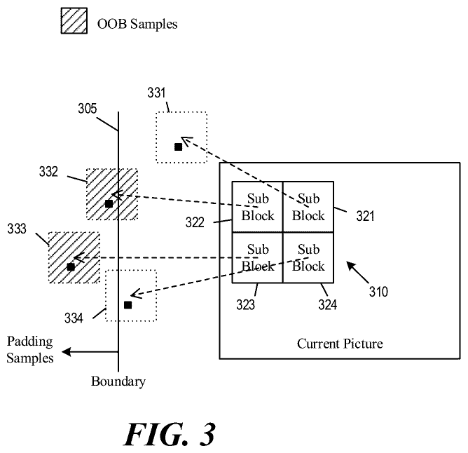

FIG. 3 conceptually illustrates performing OOB check at sub-block level. The figure illustrates a block of pixels 310 having four 4×4 sub-blocks 321-324. Each sub-block has its own corresponding MV for referring to a reference block. In the example, the corresponding MVs of the sub-blocks 321-324 refer to reference sub-blocks 331-334, respectively. For each reference sub-block, the video coder performs OOB check for one representative pixel position (shown as a black squire/dot in each reference sub-block). The OOB check result at the one representative pixel position is used as the OOB 20 result of the sub-block. The OOB is determined based on a boundary 305, which may be a picture boundary, a sub-picture boundary, a tile boundary, a slice boundary, or a virtual boundary.

In the example, for the reference sub-block 331, the representative position is within the boundary 305 (so does the entire reference sub-block 331.) The sub-block 321 is therefore considered entirely non-OOB and bi-directional motion compensation can be performed for the sub-block.

For the reference sub-block 332, the representative position is outside of the boundary 305. The video coder may consider the sub-block 322 as entirely OOB for purpose of bi-directional motion compensation (even though some portion of the reference sub-block 332 is still within the boundary 305).

For the reference block 333, the representative position is outside of the boundary 305 (so does the entire reference sub-block 333.) The sub-block 323 is therefore considered entirely OOB for purpose of bi-directional motion compensation.

For the reference sub-block 334, the representative position is inside the boundary 305. The video coder may consider the sub-block 324 as entirely non-OOB for purpose of bi-directional motion compensation, even though some portion of the reference sub-block 334 is beyond the boundary 305. In these instances, padding samples may be used for the portion of the reference sub-block 334 that lie beyond the boundary 305.

In some embodiments, the one representative position for the sub-block OOB check may be a fractional position. For example, for a 4×4 sub-block, the position (1.5, 1.5) may be used. For some embodiments, the size of the sub-block may be different depending on the prediction mode or coding tool that is used for coding the current block. For example, 4×4 sub-block size may be used for affine mode, 16×16 sub-block size may be used for DMVR mode, and 8×8 sub-block size may be used for normal bi-directional mode, etc.

In some embodiments, the corresponding MV of a sub-block may be derived from multiple MVs if the sub-block contains multiple MVs. For example, an 8×8 sub-block may have four different MVs, and the corresponding MV of the sub-block for OOB check is derived from calculating the minimum or the maximum of horizontal and vertical components of the four different MVs.

In some embodiment, more than one corresponding MVs are used for OOB check. For example, in some embodiments, a first corresponding MV for right and bottom boundary and a second corresponding MV for left and top boundary are used for OOB check. In another example, an 8×8 sub-block may have 4 different MVs, and the MV for the right and bottom boundary is derived from calculating the max of horizontal and vertical components of the 4 different MVs, and the MV for the left and top boundary is derived from calculating the min of horizontal and vertical components of the 4 different MVs.

The foregoing proposed method can be implemented in encoders and/or decoders. For example, the proposed method can be implemented in a inter prediction module and/or intra block copy prediction module of an encoder, and/or a inter prediction module (and/or intra block copy prediction module) of a decoder.

### II. Example Video Encoder

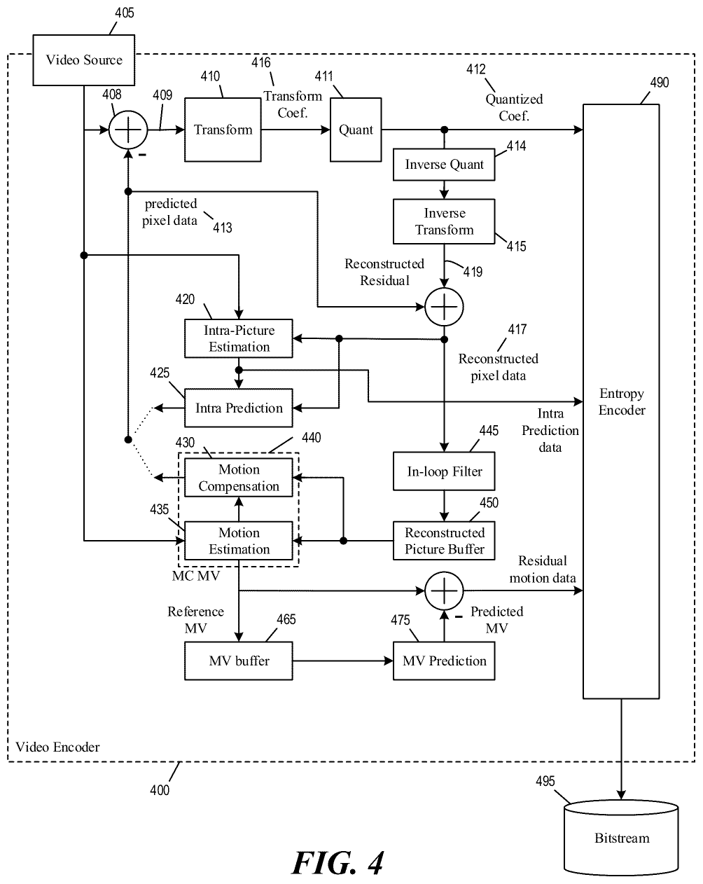

FIG. 4 illustrates an example video encoder 400 that may use out-of-bound checks when performing prediction modes. As illustrated, the video encoder 400 receives input video signal from a video source 405 and encodes the signal into bitstream 495. The video encoder 400 has several components or modules for encoding the signal from the video source 405, at least including some components selected from a transform module 410, a quantization module 411, an inverse quantization module 414, an inverse transform module 415, an intra-picture estimation module 420, an intra-prediction module 425, a motion compensation module 430, a motion estimation module 435, an in-loop filter 445, a reconstructed picture buffer 450, a MV buffer 465, and a MV prediction module 475, and an entropy encoder 490. The motion compensation module 430 and the motion estimation module 435 are part of an inter-prediction module 440.

In some embodiments, the modules 410-490 are modules of software instructions being executed by one or more processing units (e.g., a processor) of a computing device or electronic apparatus. In some embodiments, the modules 410-490 are modules of hardware circuits implemented by one or more integrated circuits (ICs) of an electronic apparatus. Though the modules 410-490 are illustrated as being separate modules, some of the modules can be combined into a single module.

The video source 405 provides a raw video signal that presents pixel data of each video frame without compression. A subtractor 408 computes the difference between the raw video pixel data of the video source 405 and the predicted pixel data 413 from the motion compensation module 430 or intra-prediction module 425 as prediction residual 409. The transform module 410 converts the difference (or the residual pixel data or residual signal 408) into transform coefficients (e.g., by performing Discrete Cosine Transform, or DCT). The quantization module 411 quantizes the transform coefficients into quantized data (or quantized coefficients) 412, which is encoded into the bitstream 495 by the entropy encoder 490.

The inverse quantization module 414 de-quantizes the quantized data (or quantized coefficients) 412 to obtain transform coefficients, and the inverse transform module 415 performs inverse transform on the transform coefficients to produce reconstructed residual 419. The reconstructed residual 419 is added with the predicted pixel data 413 to produce reconstructed pixel data 417. In some embodiments, the reconstructed pixel data 417 is temporarily stored in a line buffer (not illustrated) for intra-picture prediction and spatial MV prediction. The reconstructed pixels are filtered by the in-loop filter 445 and stored in the reconstructed picture buffer 450. In some embodiments, the reconstructed picture buffer 450 is a storage external to the video encoder 400. In some embodiments, the reconstructed picture buffer 450 is a storage internal to the video encoder 400.

The intra-picture estimation module 420 performs intra-prediction based on the reconstructed pixel data 417 to produce intra prediction data. The intra-prediction data is provided to the entropy encoder 490 to be encoded into bitstream 495. The intra-prediction data is also used by the intra-prediction module 425 to produce the predicted pixel data 413.

The motion estimation module 435 performs inter-prediction by producing MVs to reference pixel data of previously decoded frames stored in the reconstructed picture buffer 450. These MVs are provided to the motion compensation module 430 to produce predicted pixel data.

Instead of encoding the complete actual MVs in the bitstream, the video encoder 400 uses MV prediction to generate predicted MVs, and the difference between the MVs used for motion compensation and the predicted MVs is encoded as residual motion data and stored in the bitstream 495.

The MV prediction module 475 generates the predicted MVs based on reference MVs that were generated for encoding previously video frames, i.e., the motion compensation MVs that were used to perform motion compensation. The MV prediction module 475 retrieves reference MVs from previous video frames from the MV buffer 465. The video encoder 400 stores the MVs generated for the current video frame in the MV buffer 465 as reference MVs for generating predicted MVs.

The MV prediction module 475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 495 by the entropy encoder 490.

The entropy encoder 490 encodes various parameters and data into the bitstream 495 by using entropy-coding techniques such as context-adaptive binary arithmetic coding (CABAC) or Huffman encoding. The entropy encoder 490 encodes various header elements, flags, along with the quantized transform coefficients 412, and the residual motion data as syntax elements into the bitstream 495. The bitstream 495 is in turn stored in a storage device or transmitted to a decoder over a communications medium such as a network.

The in-loop filter 445 performs filtering or smoothing operations on the reconstructed pixel data 417 to reduce the artifacts of coding, particularly at boundaries of pixel blocks. In some embodiments, the filtering or smoothing operations performed by the in-loop filter 445 include deblock filter (DBF), sample adaptive offset (SAO), and/or adaptive loop filter (ALF).

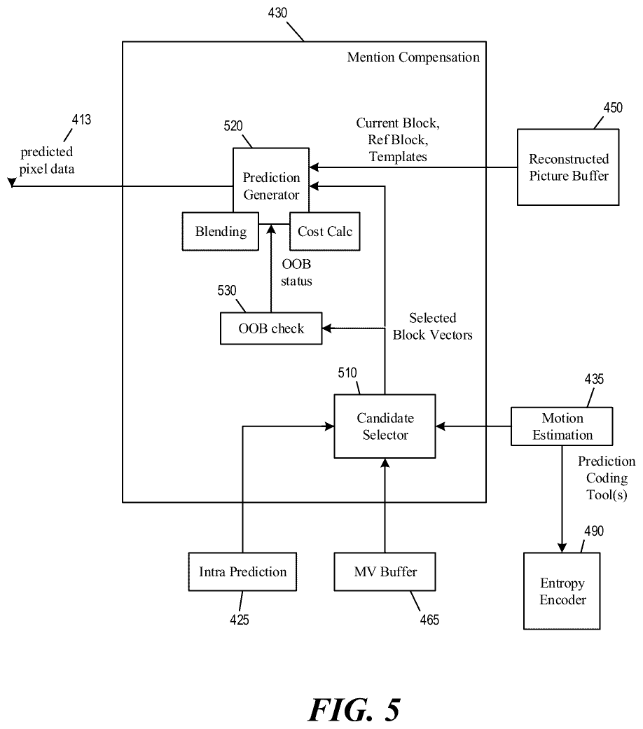

FIG. 5 illustrates portions of the video encoder 400 that implement out-of-bound checks for predictive coding. Specifically, the figure illustrates the components of the motion compensation module 430 of the video encoder 400.

As illustrated, the motion compensation module 430 has a candidate selector 510 that selects block vectors (including motion vectors and intra prediction modes) from the MV buffer 465 and the intra prediction module 425. The selection is controlled by the motion estimation module 435. The selected block vectors are examined by a OOB check module 530, which determines whether the reference blocks identified by the block vectors are out-of-bound. The selected block vectors are also provided to a prediction generator module 520.

The OOB check module 530 performs the OOB check of the identified reference block based on a boundary of the video coding hierarchy. In some embodiments, the OOB check is based on a picture boundary of the reference picture from which the reference block is obtained. In some embodiments, the OOB check is based on a boundary of a sub-picture unit that includes (at least part of) the reference block, a sub-picture unit such as a slice, a tile, or a pipeline data unit.

In some embodiments, the OOB check module 530 checks each pixel position or each sample of the reference block for out-of-bound condition. In some embodiments, the OOB check module 530 divide the current block into sub-blocks and performs OOB check for each sub-block (e.g., 4×4 or 8×8). Specifically, for each sub-block, the OOB check module determines a corresponding motion vector and then performs OOB check at a representative pixel position of a reference sub-block identified by the corresponding motion vector.

The prediction generator module 520 generates a predictor or prediction block for the current block as the predicted pixel data 413 by fetching samples from the reconstructed picture buffer 450. The motion estimation module 435 selects one or more prediction coding tools for the current block (e.g., bi-prediction, GPM, CIIP, MHP, intra-prediction, IBC, etc.), and the prediction generator module 520 generates the predictor based on the selected prediction tool(s). The motion estimation module 435 also provides the prediction tool selection to the entropy encoder 490 to be signaled in the bitstream 495.

The predictor generator module 520 also uses the OOB check result from the OOB check module 530 to determine whether to exclude certain reference samples identified by the selected block vector(s) when performing blending to generate the predictor for bi-directional motion compensation. In some embodiments, sub-blocks that are determined to be OOB by the OOB check module 530 are excluded from blending for bi-directional motion compensation, while sub-blocks that are determined to be non-OOB are included in the blending for bi-directional motion compensation.

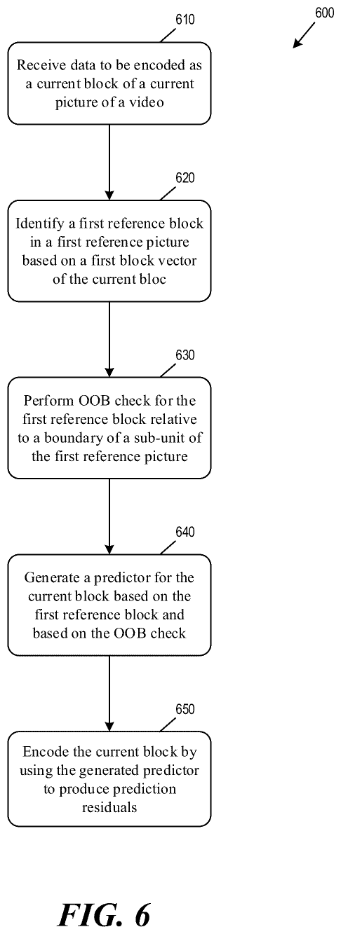

FIG. 6 conceptually illustrates a process 600 for using out-of-bound checks when performing predictive coding of a block of pixels. In some embodiments, one or more processing units (e.g., a processor) of a computing device implementing the encoder 400 performs the process 600 by executing instructions stored in a computer readable medium. In some embodiments, an electronic apparatus implementing the encoder 400 performs the process 600.

The encoder receives (at block 610) data to be encoded as a current block of a current picture of a video. The encoder identifies (at block 620) a first reference block in a first reference picture based on a first block vector of the current block. The encoder may also identify a second reference block in a second reference pictures based on a second block vector of the current block.

The encoder performs (at block 630) out-of-bound (OOB) check for the first reference block relative to a boundary of a sub-unit of the first reference picture. The encoder may also perform OOB check for the second reference block. The sub-unit may be a slice, a tile, or a pipeline data unit of the first reference picture.

In some embodiments, the current block may be one of a plurality of sub-blocks of a larger block, and the OOB check of the first reference block is performed on only one representative pixel position in the first reference block. The representative pixel position may be a fractional position. The size of a sub-block may be determined based on a coding tool that is used for encoding or decoding the current block.

For each sub-block, the encoder may identify a reference block in a reference picture, perform OOB check for the identified reference block relative to a boundary of a sub-unit of the reference picture at only the representative pixel position and no other pixel position in the reference block, and determines whether to perform bi-directional motion compensation for all samples of the sub-block based on the OOB check at the representative pixel position. The encoder may derive a corresponding motion vector from multiple motion vectors of the sub-block, and may use the corresponding motion vector to identify a reference block for the sub-block. In some embodiments, the corresponding motion vector of the sub-block is derived from calculating the minimum or the maximum of horizontal and vertical components of the multiple motion vectors of the sub-block.

The encoder generates (at block 640) a predictor for the current block based on the first reference block and based on the OOB check. The predictor may be generated for bi-directional motion compensation based on the first and second reference blocks and based on the OOB checks of the first and second reference blocks. In some embodiments, when a sample of the first reference block is OOB, the sample is not used in a bi-directional motion compensation for the current block. In some embodiments in which the current block is one of several sub-blocks of the larger block, when a sample at the representative pixel position is OOB, a bi-directional motion compensation is not applied for the sub-block.

The encoder encodes (at block 650) the current block by using the generated predictor to produce prediction residuals.

### III. Example Video Decoder

In some embodiments, an encoder may signal (or generate) one or more syntax element in a bitstream, such that a decoder may parse said one or more syntax element from the bitstream.

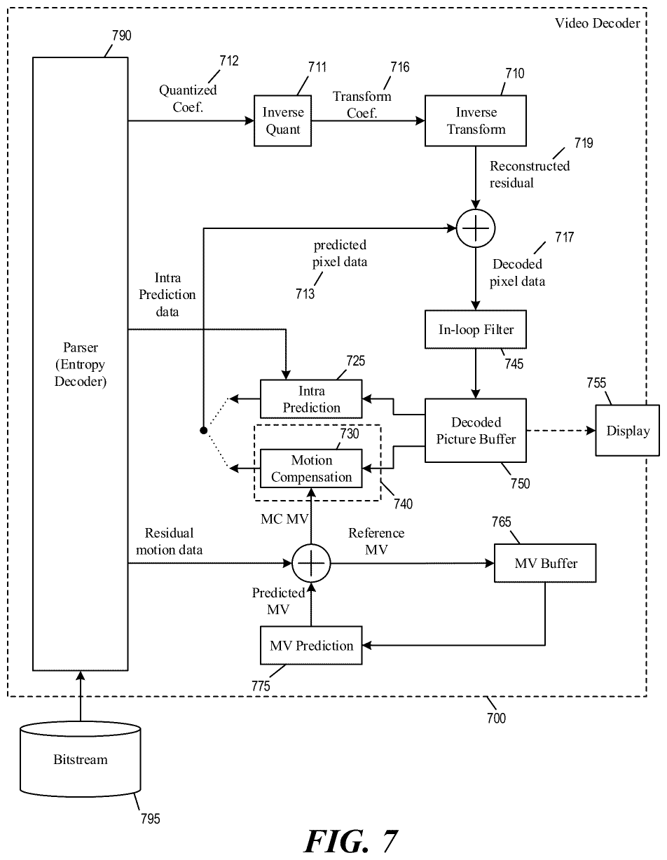

FIG. 7 illustrates an example video decoder 700 that may use out-of-bound checks when performing prediction modes. As illustrated, the video decoder 700 is an image-decoding or video-decoding circuit that receives a bitstream 795 and decodes the content of the bitstream into pixel data of video frames for display. The video decoder 700 has several components or modules for decoding the bitstream 795, including some components selected from an inverse quantization module 711, an inverse transform module 710, an intra-prediction module 725, a motion compensation module 730, an in-loop filter 745, a decoded picture buffer 750, a MV buffer 765, a MV prediction module 775, and a parser 790. The motion compensation module 730 is part of an inter-prediction module 740.

In some embodiments, the modules 710-790 are modules of software instructions being executed by one or more processing units (e.g., a processor) of a computing device. In some embodiments, the modules 710-790 are modules of hardware circuits implemented by one or more ICs of an electronic apparatus. Though the modules 710-790 are illustrated as being separate modules, some of the modules can be combined into a single module.

The parser 790 (or entropy decoder) receives the bitstream 795 and performs initial parsing according to the syntax defined by a video-coding or image-coding standard. The parsed syntax element includes various header elements, flags, as well as quantized data (or quantized coefficients) 712. The parser 790 parses out the various syntax elements by using entropy-coding techniques such as context-adaptive binary arithmetic coding (CABAC) or Huffman encoding.

The inverse quantization module 711 de-quantizes the quantized data (or quantized coefficients) 712 to obtain transform coefficients, and the inverse transform module 710 performs inverse transform on the transform coefficients 716 to produce reconstructed residual signal 719. The reconstructed residual signal 719 is added with predicted pixel data 713 from the intra-prediction module 725 or the motion compensation module 730 to produce decoded pixel data 717. The decoded pixels data are filtered by the in-loop filter 745 and stored in the decoded picture buffer 750. In some embodiments, the decoded picture buffer 750 is a storage external to the video decoder 700. In some embodiments, the decoded picture buffer 750 is a storage internal to the video decoder 700.

The intra-prediction module 725 receives intra-prediction data from bitstream 795 and according to which, produces the predicted pixel data 713 from the decoded pixel data 717 stored in the decoded picture buffer 750. In some embodiments, the decoded pixel data 717 is also stored in a line buffer (not illustrated) for intra-picture prediction and spatial MV prediction.

In some embodiments, the content of the decoded picture buffer 750 is used for display. A display device 755 either retrieves the content of the decoded picture buffer 750 for display directly, or retrieves the content of the decoded picture buffer to a display buffer. In some embodiments, the display device receives pixel values from the decoded picture buffer 750 through a pixel transport.

The motion compensation module 730 produces predicted pixel data 713 from the decoded pixel data 717 stored in the decoded picture buffer 750 according to motion compensation MVs (MC MVs). These motion compensation MVs are decoded by adding the residual motion data received from the bitstream 795 with predicted MVs received from the MV prediction module 775.

The MV prediction module 775 generates the predicted MVs based on reference MVs that were generated for decoding previous video frames, e.g., the motion compensation MVs that were used to perform motion compensation. The MV prediction module 775 retrieves the reference MVs of previous video frames from the MV buffer 765. The video decoder 700 stores the motion compensation MVs generated for decoding the current video frame in the MV buffer 765 as reference MVs for producing predicted MVs.

The in-loop filter 745 performs filtering or smoothing operations on the decoded pixel data 717 to reduce the artifacts of coding, particularly at boundaries of pixel blocks. In some embodiments, the filtering or smoothing operations performed by the in-loop filter 745 include deblock filter (DBF), sample adaptive offset (SAO), and/or adaptive loop filter (ALF).

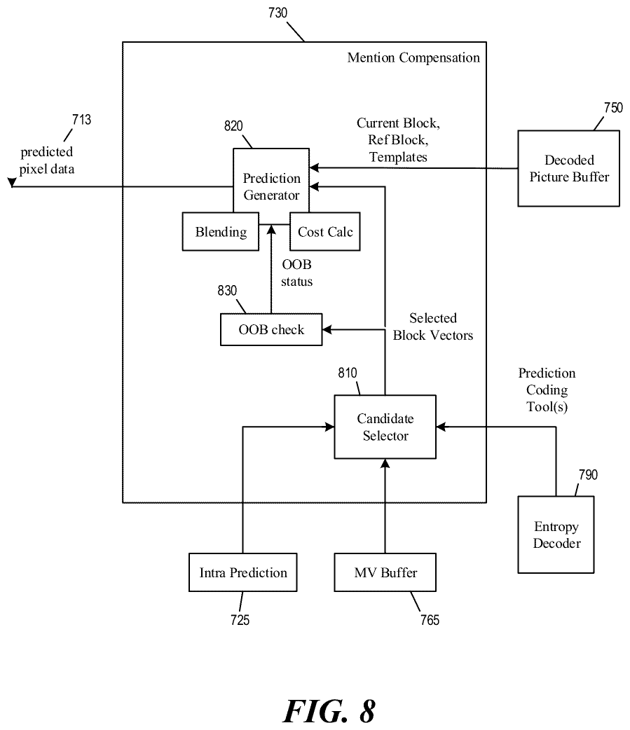

FIG. 8 illustrates portions of the video decoder 700 that implement out-of-bound checks for predictive coding. Specifically, the figure illustrates the components of the motion compensation module 730 of the video decoder 700.

As illustrated, the motion compensation module 730 has a candidate selector 810 that selects block vectors (including motion vectors and intra prediction modes) from the MV buffer 765 and the intra prediction module 725. The selection is controlled by the entropy decoder 790. The selected block vectors are examined by a OOB check module 830, which determines whether the reference blocks identified by the block vectors are out-of-bound. The selected block vectors are also provided to a prediction generator module 820.

The OOB check module 830 performs the OOB check of the identified reference block based on a boundary of the video coding hierarchy. In some embodiments, the OOB check is based on a picture boundary of the reference picture from which the reference block is obtained. In some embodiments, the OOB check is based on a boundary of a sub-picture unit that includes (at least part of) the reference block, a sub-picture unit such as a slice, a tile, or a pipeline data unit.

In some embodiments, the OOB check module 830 checks each pixel position or each sample of the reference block for out-of-bound condition. In some embodiments, the OOB check module 830 divide the current block into sub-blocks and performs OOB check for each sub-block (e.g., 4×4 or 8×8). Specifically, for each sub-block, the OOB check module determines a corresponding motion vector and then performs OOB check at a representative pixel position of a reference sub-block identified by the corresponding motion vector.

The prediction generator module 820 generates a predictor or prediction block for the current block as the predicted pixel data 713 by fetching samples from the decoded picture buffer 750. The entropy decoder 790 selects one or more prediction coding tools for the current block (e.g., bi-prediction, GPM, CIIP, MHP, intra-prediction, IBC, etc.), and the prediction generator module 820 generates the predictor based on the selected prediction tool(s). The entropy decoder 790 also provides the prediction tool selection to the entropy decoder 790 to be signaled in the bitstream 795.

The predictor generator module 820 also uses the OOB check result from the OOB check module 830 to determine whether to exclude certain reference samples identified by the selected block vector(s) when performing blending to generate the predictor for bi-directional motion compensation. In some embodiments, sub-blocks that are determined to be OOB by the OOB check module 830 are excluded from blending for bi-directional motion compensation, while sub-blocks that are determined to be non-OOB are included in the blending for bi-directional motion compensation.

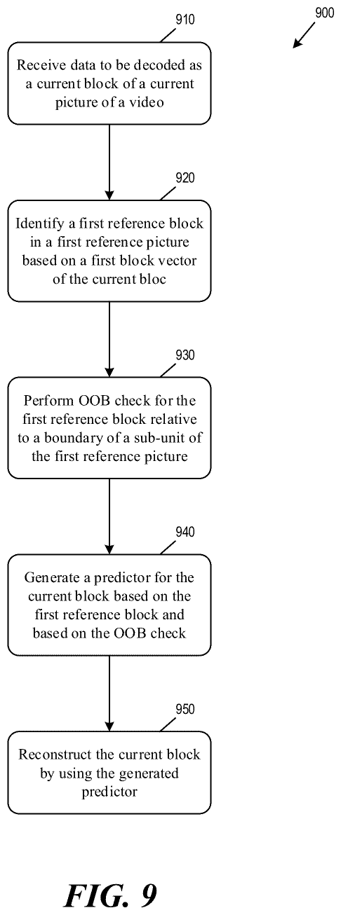

FIG. 9 conceptually illustrates a process 900 for using out-of-bound checks when performing predictive coding of a block of pixels. In some embodiments, one or more processing units (e.g., a processor) of a computing device implementing the decoder 700 performs the process 900 by executing instructions stored in a computer readable medium. In some embodiments, an electronic apparatus implementing the decoder 700 performs the process 900.

The decoder receives (at block 910) data to be decoded as a current block of a current picture of a video. The decoder identifies (at block 920) a first reference block in a first reference picture based on a first block vector of the current block. The decoder may also identify a second reference block in a second reference pictures based on a second block vector of the current block.

The decoder performs (at block 930) out-of-bound (OOB) check for the first reference block relative to a boundary of a sub-unit of the first reference picture. The decoder may also perform OOB check for the second reference block. The sub-unit may be a slice, a tile, or a pipeline data unit of the first reference picture.

In some embodiments, when a sample of the first reference block is OOB, the sample is not used in a bi-directional motion compensation for the current block. In some embodiments in which the current block is one of several sub-blocks of the larger block, when a sample at the representative pixel position is OOB, a bi-directional motion compensation is not applied for the sub-block.

In some embodiments, the current block may be one of a plurality of sub-blocks of a larger block, and the OOB check of the first reference block is performed on only one representative pixel position in the first reference block. The representative pixel position may be a fractional position. The size of a sub-block may be determined based on a coding tool that is used for decoding or decoding the current block.

For each sub-block, the decoder may identify a reference block in a reference picture, perform OOB check for the identified reference block relative to a boundary of a sub-unit of the reference picture at only the representative pixel position and no other pixel position in the reference block, and determines whether to perform bi-directional motion compensation for all samples of the sub-block based on the OOB check at the representative pixel position. The decoder may derive a corresponding motion vector from multiple motion vectors of the sub-block, and may use the corresponding motion vector to identify a reference block for the sub-block. In some embodiments, the corresponding motion vector of the sub-block is derived from calculating the minimum or the maximum of horizontal and vertical components of the multiple motion vectors of the sub-block.

The decoder generates (at block 940) a predictor for the current block based on the first reference block and based on the OOB check. The predictor may be generated for bi-directional motion compensation based on the first and second reference blocks and based on the OOB checks of the first and second reference blocks. In some embodiments, when a sample of the first reference block is OOB, the sample is not used in a bi-directional motion compensation for the current block. In some embodiments in which the current block is one of several sub-blocks of the larger block, when a sample at the representative pixel position is OOB, a bi-directional motion compensation is not applied for the sub-block.

The decoder reconstructs (at block 950) the current block by using the generated predictor. The decoder may then provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

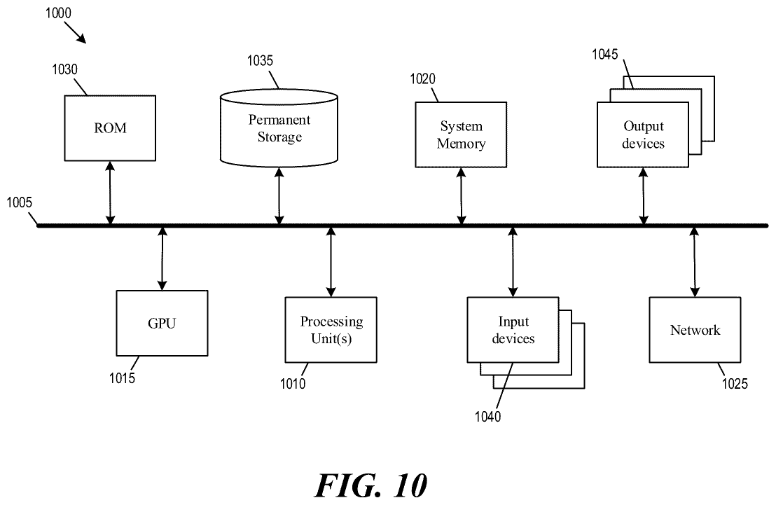

FIG. 10 conceptually illustrates an electronic system 1000 with which some embodiments of the present disclosure are implemented. The electronic system 1000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1000 includes a bus 1005, processing unit(s) 1010, a graphics-processing unit (GPU) 1015, a system memory 1020, a network 1025, a read-only memory 1030, a permanent storage device 1035, input devices 1040, and output devices 1045.

The bus 1005 collectively represents all system, peripheral, and chipset buses that communicatively connect the numerous internal devices of the electronic system 1000. For instance, the bus 1005 communicatively connects the processing unit(s) 1010 with the GPU 1015, the read-only memory 1030, the system memory 1020, and the permanent storage device 1035.

From these various memory units, the processing unit(s) 1010 retrieves instructions to execute and data to process in order to execute the processes of the present disclosure. The processing unit(s) may be a single processor or a multi-core processor in different embodiments. Some instructions are passed to and executed by the GPU 1015. The GPU 1015 can offload various computations or complement the image processing provided by the processing unit(s) 1010.

The read-only-memory (ROM) 1030 stores static data and instructions that are used by the processing unit(s) 1010 and other modules of the electronic system. The permanent storage device 1035, on the other hand, is a read-and-write memory device. This device is a non-volatile memory unit that stores instructions and data even when the electronic system 1000 is off. Some embodiments of the present disclosure use a mass-storage device (such as a magnetic or optical disk and its corresponding disk drive) as the permanent storage device 1035.

Other embodiments use a removable storage device (such as a floppy disk, flash memory device, etc., and its corresponding disk drive) as the permanent storage device. Like the permanent storage device 1035, the system memory 1020 is a read-and-write memory device. However, unlike storage device 1035, the system memory 1020 is a volatile read-and-write memory, such a random access memory. The system memory 1020 stores some of the instructions and data that the processor uses at runtime. In some embodiments, processes in accordance with the present disclosure are stored in the system memory 1020, the permanent storage device 1035, and/or the read-only memory 1030. For example, the various memory units include instructions for processing multimedia clips in accordance with some embodiments. From these various memory units, the processing unit(s) 1010 retrieves instructions to execute and data to process in order to execute the processes of some embodiments.

The bus 1005 also connects to the input and output devices 1040 and 1045. The input devices 1040 enable the user to communicate information and select commands to the electronic system. The input devices 1040 include alphanumeric keyboards and pointing devices (also called “cursor control devices”), cameras (e.g., webcams), microphones or similar devices for receiving voice commands, etc. The output devices 1045 display images generated by the electronic system or otherwise output data. The output devices 1045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 10, bus 1005 also couples electronic system 1000 to a network 1025 through a network adapter (not shown). In this manner, the computer can be a part of a network of computers (such as a local area network (“LAN”), a wide area network (“WAN”), or an Intranet, or a network of networks, such as the Internet. Any or all components of electronic system 1000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 6 and FIG. 9) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of a current picture of a video;
identifying a first reference block in a first reference picture based on a first block vector of the current block;
performing out-of-bound (OOB) check for the first reference block relative to a boundary of a sub-unit of the first reference picture;
generating a predictor for the current block based on the first reference block and based on the OOB check; and
encoding or decoding the current block by using the generated predictor.

2. The video coding method of claim 1, further comprising:
identifying a second reference block in a second reference pictures based on a second block vector of the current block; and
performing OOB check for the second reference block,
wherein the predictor is generated based on the first and second reference blocks and based on the OOB checks of the first and second reference blocks.

3. The video coding method of claim 1, wherein when a sample of the first reference block is OOB, the sample is not used in a bi-directional motion compensation for the current block.

4. The video coding method of claim 1, wherein the sub-unit is one of a slice, a tile, or a pipeline data unit of the first reference picture.

5. The video coding method of claim 1, wherein the current block is one of a plurality of sub-blocks of a larger block, wherein the OOB check of the first reference block is performed on only one representative pixel position in the first reference block.

6. The video coding method of claim 5, wherein when a sample at the representative pixel position is OOB, a bi-directional motion compensation is not applied for the sub-block.

7. The video coding method of claim 5, wherein the representative pixel position is a fractional position.

8. The video coding method of claim 5, further comprising, for each sub-block of the larger block:
identifying a reference block in a reference picture;
performing OOB check for the identified reference block relative to a boundary of a sub-unit of the reference picture at only the representative pixel position and no other pixel position in the reference block; and
determining whether to perform bi-directional motion compensation for all samples of the sub-block based on the OOB check at the representative pixel position.

9. The video coding method of claim 5, wherein a size of a sub-block is determined based on a coding tool that is used for encoding or decoding the current block.

10. The video coding method of claim 5, wherein a corresponding motion vector derived from a plurality of motion vectors of the sub-block is used to identify a reference block for the sub-block.

11. The video coding method of claim 10, wherein the corresponding motion vector of the sub-block is derived from calculating a minimum or a maximum of horizontal and vertical components of the plurality of motion vectors of the sub-block.

12. An electronic apparatus comprising:
a video coder circuit configured to perform operations comprising:
receiving data to be encoded or decoded as a current block of a current picture of a video;
identifying a first reference block in a first reference picture based on a first block vector of the current block;
performing out-of-bound (OOB) check for the first reference block relative to a boundary of a sub-unit of the first reference picture;
generating a predictor for the current block based on the first reference block and based on the OOB check; and
encoding or decoding the current block by using the generated predictor.

13. A video decoding method comprising:
receiving data to be decoded as a current block of a current picture of a video;
identifying a first reference block in a first reference picture based on a first block vector of the current block;
performing out-of-bound (OOB) check for the first reference block relative to a boundary of a sub-unit of the first reference picture;
generating a predictor for the current block based on the first reference block and based on the OOB check; and
reconstructing the current block by using the generated predictor.
